(19) United States
(12) Patent Application Publication
(10) Pub. No.: US 2009/0007746 A1
(43) Pub. Date: Jan. 8, 2009

(54) Lightweight tabletop shearing apparatus

(76) Inventor: Dalen Eugene Gunn, Hayden, ID (US)

Correspondence Address: PATENT LAW & VENTURE GROUP, 2424 S.E. BRISTOL, SUITE 300, NEWPORT BEACH, CA, 92660, US

(21) Appl. No.: 11/825,423

(22) Filed: Jul. 6, 2007

(51) Int. Cl. B26D 5/08; B26D 1/08

(52) U.S. Cl. 83/548; 83/558

(57) ABSTRACT

A material shearing apparatus uses a horizontal receiver bar in support of a pair of spaced apart vertical guide rods having retainer blocks fixed in place on them, and a shearing head slidingly engaged with the guide rods so as to move between raised and lowered positions. A camshaft rotates eccentrically in the retainer blocks so as to bear on the shearing head which is thereby moved downwardly against return springs.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to shearing machines and more particularly to a shearing machine that is relatively light in weight and may be easily moved from place to place for shearing flooring materials including hard materials.

2. Description of Related Art Including Information Disclosed Under 37 CFR 1.97 and 1.98

Gatzke, U.S. Pat. No. 2,657,681 discloses a manually operable hydraulic jack mounted on a top plate of a beam structure in such a manner that a vertically movable piston or lifting member of the jack engages a lower edge of a lower knife structure. Two vertical screw spindles extend through the beam structure and are each adapted to lock to the latter in a desired position by a pair of clamping nuts, one engaging the top and the other the bottom plate of the beam structure. The upper ends of the screw spindles are each pivotally connected at one point with the lower ends of a pair of links or straps extending vertically upwardly through a slot in the table top to be pivotally connected at the ends of a pair of horizontal mounting plates which have fixedly secured therebetween an upper splitting knife.

Gundlach, U.S. Pat. No. 1,814,151, discloses a cutting device comprising a body portion, a knife blade mounted therein, a knife carrier located above the body portion and pivotally secured thereto, a knife blade mounted in the pivoted carrier for cooperation with the knife blade on the body member, means mounted on the body member and operatively engaging the free end of the pivoted knife carrier to actuate the latter, and means for varying the pivot point of the pivoted knife carrier, the means comprising a threaded stud slidably mounted on the body member and pivotally supporting the knife carrier, a spring for supporting the threaded stud, and a nut threaded on the stud and adapted to be held in abutting relation to the body member by the action of the stud supporting spring.

Van Loon, U.S. Pat. No. 2,679,840, discloses an apparatus of the class described comprising a frame, a fixed lower blade, an upper blade, means for movably mounting the upper blade above the lower blade including a piston connected to the upper blade and a cylinder for the piston, means for supplying each end of the cylinder with fluid pressure, means controlling the flow of fluid pressure to the cylinder including a valve having a moveable valve member, the moveable valve member having an upper position in which fluid may be supplied to the upper side of the piston to urge the upper blade downwardly, a lower position in which fluid is supplied to the lower side of the piston to urge the upper blade upwardly and a neutral position in which fluid to and from the cylinder is stopped, a stop carried by the upper blade engagable with the movable valve member to shift the movable value member to a neutral position when the upper blade is in its upper position, means for urging the valve member downwardly, and means for manually shifting the valve member into its upper position to cause the piston to move the upper blade downwardly and to carry the stop therewith.

Petch, U.S. Pat. No. 2,746,447, discloses a block splitting machine, a frame including an upper portion, a vertically movable blade suspended from the upper frame portion, means for vertically reciprocating the movable blade, a second blade fixedly secured to the frame below the movable blade and in vertical register therewith, a table disposed between the fixed and moveable blades, means normally urging the table to its upper position, the table having an opening therein to receive the fixed blade when the table is depressed, means supported by the frame at one side of the table for delivering blocks to be split onto the table, the last means comprising a pair of spaced, parallel roller supports and mechanism disposed between the roller supports for moving blocks along the roller supports onto the table, the mechanism including a hydraulic cylinder fixed to the frame, a piston rod extending from the cylinder between the roller supports, and fingers pivotally carried by the free end of the piston rod adapted to engage a block supported by the rollers and move the same onto the table.

Celapino, U.S. Pat. No. 2,808,822, discloses a stone cutting machine comprising two oppositely disposed rows of knives that are of generally chisel form, the knives of each row normally having their edges in approximately longitudinal alignment, supporting brackets for the rows, means for moving the brackets relatively to each other in a direction to thereby engage the respective rows of knives against opposite faces of a slab, a flexible tube held in the bracket and engaged by the outer ends of the knives in each row, and means for retaining fluid pressure in the tubes, at a degree that will prevent collapse of the tubes under shearing stresses.

Mayer, U.S. Pat. No. 3,098,476, discloses a stone splitter, a pressure equalizing device comprising a hollow base; a support including a pair of spaced elongated plate elements; first shaft means pivotally mounting the plate elements within the base for vertical rocking movement relative to the latter; a pair of horizontally spaced primary members; second shaft means pivotally mounting the primary members; second shaft means pivotally mounting the primary members on the support between the elements for vertical rocking movement relative to the latter; a pair of horizontally spaced secondary members for each primary member; third shaft means pivotally mounting the secondary members on corresponding primary members or vertical rocking movement relative thereto, the secondary members projecting upwardly from the corresponding primary member to provide stone along two spaced lines, the axes of pivotal movement of the primary and secondary members being substantially coplanar.

Crawford, U.S. Pat. No. 3,297,015, discloses a masonry cutter which comprises, a base, a pair of track-forming uprights fastened to the base in upstanding spaced parallel relation to one another, a stationary blade supported in fixed position on the base and extending upwardly therefrom in the plane defined by the uprights, the stationary blade having the exposed upper edge thereof sharpened, horizontally-disposed vertically adjustable tray means having upstanding side walls and located adjacent the stationary blade on one side thereof adapted to support the material to be cut in overhanging relation to the stationary blade and in position to maintain substantially continuous line contact therewith, a reciprocating frame mounted on the uprights or vertical sliding movement thereon and spanning the space there between, a movable blade secured within the reciprocating frame for movement therewith, the movable blade having the lower edge thereof sharpened and exposed to lie in co-planar relation to the sharpened edge of the stationary blade, the frame and movable blade cooperating to provide a cutter assembly that can be raised on the tack forming uprights and allowed to drop free onto the top of the material to be cut with a guillotine-like impact fracturing action, and means comprising at least one compression spring mounted on one of the uprights between movable blade from contacting the fixed blade registering apertures in one of the uprights and the reciprocating frame and latch pin means releasably fitted into the apertures to interconnect the reciprocating frame and the track forming uprights to lock the movable blade in fixed position.

Diolot, U.S. Pat. No. 3,524,374, discloses a rapid-cutting guillotine shearing machine for continuously moving metal sheet, the cutting blade being controlled by a fluid jack having a reciprocating jack rod executing one cut for each direction of movement of the jack rod, the jack being supplied with fluid by an electromagnetic valve having a fluid passage of considerable cross section, the jack rod being provided with end-of-travel damping device.

Krauss, U.S. Pat. No. 3,754,492, discloses a sheet cutting apparatus powered wholly by hydraulics including a blade for cutting and a hydraulically operated clamping bar for holding the sheet material in place for cutting after clamping has been effected.

Blackman et al., U.S. Pat. No. 5,125,549, discloses an invention that relates to a method and apparatus for scoring and breaking an optical fiber and, specifically, for scoring and breaking an optical fiber near a ferrule forming an end face substantially normal to the longitudinal axis of the optical fiber.

Waggoner et al., U.S. Pat. No. 5,570,678, discloses a shearing tool for cutting cement siding which includes upper and lower blade holders. Each blade holder has first and second ends and an elongated slot extending substantially there between. The blade holders are positioned so that the slots face each other and are substantially aligned. Upper and lower blades are removably mounted in the slots of the upper and lower blade holders, respectively. The upper and lower blades each have a relatively narrow cross-sectional width and a cutting edge. When positioned in the slots of the blade holders, the upper and lower blades define a cutting plane in which the cutting edges are substantially aligned and face each other. A number of links are operatively connected to the ends of the blade holders so that either the upper or lower blade holder can move towards the other in the cutting plane. The links are configured so that the cutting edges of the blades are substantially parallel upon engaging a cement siding work piece in a closed position, and an actuator is connected to at least one of the links for moving either the upper or lower blade holders towards the other to engage the upper and lower blades with the siding in the closed position.

Giacomelli, U.S. Pat. No. 5,662,094, discloses a guillotine cutting apparatus for solid bodies of hard brittle materials such as building bricks, blocks and stone, that has a base member mounting a movable cutter for engagement with the body and cutting force applying means which imparts an impact cutting force to the cutter. Preferably a measuring frame for determining the length of the body parts that are to be cut comprises a movable stop member against which one end of the body is butted, the stop member being resiliently mounted in the frame to permit its movement away from the cutting plane as the body is cut. Preferably the cutting force applying means comprise a hand operated hammer slidably mounted on a relatively long shaft connected to the cutter member and guided by the shaft into contact with an anvil on the shaft, thereby imparting a stored energy high impact cutting force to the movable cutter. Preferably also a body receiving member to one side of the cutting plane is resiliently mounted for vertical movement and permits downward movement of the cut part of the body toward the base member as it is cut under the action of the cutting force. Preferably further a second cutter member in the same cutting plane engages the bottom surface of the body for simultaneous cutting engagement with the body.

Richard, U.S. Pat. No. 6,138,657, discloses a stone cutter for cutting stock stone, in particular marble without causing undesirable and uneconomical breakage of the stone. The stone cutter comprises a movable cutter blade assembly, where the movable cutter blade assembly comprises a movable blade holder and an upper cutter blade; a stationary blade assembly, where the stationary blade assembly comprises a stationary blade holder and a stationary blade. The movable cutter blade assembly is mounted proximate an end of the stationary blade assembly. The stone cutter further comprises a support, where the support comprises at least a base and a table and provides a stable rest for the stationary blade assembly. A handle assembly is also provided to move the movable cutter blade assembly in a linear reciprocating motion toward and away from the stationary blade assembly. The distance between the stationary blade and movable blade are generally equidistant throughout movement of the movable cutter blade assembly. The handle assembly further comprises a generally U-shaped force distributor that contacts an upper surface of the movable cutter blade assembly so as to apply an evenly distributed force on the movable cutter blade assembly. An adjustment adjusts a distance between the stationary blade and the movable blade so stock piece of stone can be inserted between the movable blade and the stationary blade prior to movement of the handle assembly.

Snell, U.S. Pat. No. 6,240,913, discloses a splitter for splitting stone, concrete, wood and the like comprising a frame, a first splitter blade moveable relative to the frame, a second splitter blade, and hydraulically actuating means for pulling the first splitter blade towards the second splitter blade to effect said splitting. The hydraulically actuatable means (preferably acts on end portions of the first blade to provide increased leverage for the splitting operation. The first blade is preferably provided with centering means for urging the first blade into a central position when it has been moved to one side during the splitting operation.

Hernblom et al., U.S. Pat. No. 6,401,706, discloses a foldable and transportable stone cutting system for cutting and shaping stones in a field, construction sites and the like. The stone cutter system is so designed that a major cutting portion, e.g., the upper guillotine element, may be folded down during transport. This improved stone cutter system has made remote or on-site construction work more feasible and at the same time has enhanced its safety during transport. This system possesses the characteristics needed for safe operation. Relevant methods and other disclosures of system operation are discussed.

Baird et al., U.S. Pat. No. 6,568,577, discloses an apparatus for splitting solid and hollow masonry materials. The apparatus includes changeable support tables and upper splitting blades to accommodate various types of masonry materials. A hydraulic ram is operated via a foot pedal to increase the pressure in the ram to raise a lower cutting blade and spring-loaded support table to exert upward and downward pressure on the material, coming it to clearly split. The upper blade is height-adjustable and the support table can be fixed in a lowered position to facilitate the splitting process by eliminating overly repetitive operation of the hydraulic ram.

Kenji, Japan 10329132, discloses a hydraulic tile cutter that comprises a lower support arm and an upper support arm, opposed to each other, between which a tile is interposed, and blade members supported pivotally on each of both ends of the lower support arm and the upper support arm with the tips of the blade members being brought into contact with the position intended for cutting of the tile. In this case, a lever is activated vertically to apply a hydraulic pressure from a hydraulic pump to a hydraulic cylinder, so that the entire length of the hydraulic cylinder contracts. At this time, a distance between four sets of opposed blade members becomes a narrow and consequently, the tile receives a shearing force at four dispersed positions on a line intended to cutting the tile.

The related art described above discloses a wide range of shearing and cutting type machines. However, the prior art fails to disclose a light-weight, portable, table-top type cutter that may be manually or auto-mechanically operated. The prior art particularly fails to disclose an eccentric bearing member for driving a cutter head, and also fails to disclose a combination linkage having a rocker arm and push rod for mechanized direct driving of a cutter head. The present disclosure distinguishes over the prior art providing these and other heretofore unknown advantages as described in the following summary.

### BRIEF SUMMARY OF THE INVENTION

This disclosure teaches certain benefits in construction and use which give rise to the objectives described below.

A material shearing apparatus small enough to be carried from place to place may be positioned on a table top. It uses a horizontal receiver bar in support of a pair of spaced apart vertical guide rods having retainer blocks fixed in place on them, and a shearing head slidingly engaged with the guide rods so as to move between raised and lowered positions. In a manual version, a lever driven camshaft rotates eccentrically in the retainer blocks so as to bear on the shearing head which is thereby moved downwardly against return springs. In an auto-mechanized version, pneumatic cylinders operate linkages that drive the shearing head directly to move a blade in the shearing head toward the receiver bar to cut through a workpiece. The springs again return the head to its original position.

A primary objective inherent in the above described shearing apparatus and method of use is to provide advantages not taught by the prior art.

Another objective is to provide such an apparatus that is relatively small and lightweight yet capable of severing hard materials such as ceramic and stone.

A further objective is to provide such an apparatus that may be operated either manually or auto-mechanically.

A yet further objective is to provide such an apparatus that uses a manually operated eccentric bearing member for driving a cutting head.

A still further objective is to provide such an apparatus that uses a linear actuator driving the cutting head through a novel linkage.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a side perspective view of the presently described apparatus;

FIG. 2 is a rear perspective view thereof; and

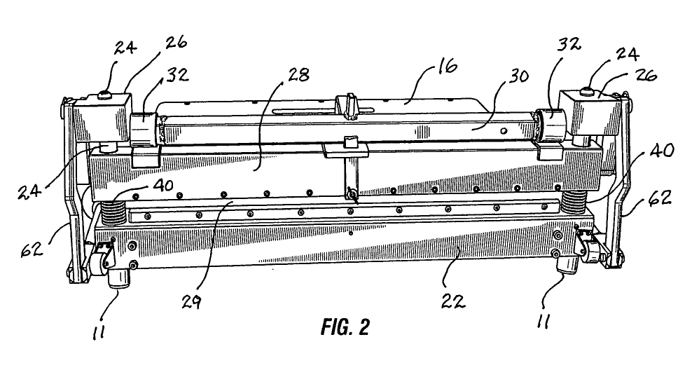

FIG. 3 is an artistic rendering thereof as seen from the rear in perspective and wherein the bed of the invention is not depicted.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

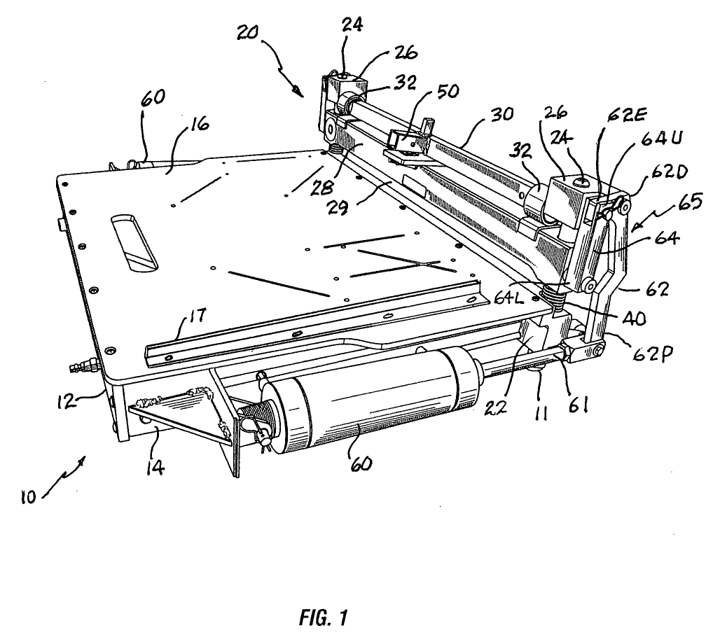

Described now in detail is a material shearing apparatus for use in severing materials such as tile and wood flooring and similar materials. As shown in FIG. 1, a rectangular bed 10 is adapted with feet 11 for resting on a surface such as a table or a floor where materials cutting is conveniently accomplished. The bed 10 may comprise an open frame with a front 12, left (not shown), right 14 and rear 22 sides, each a structural member, and having a horizontally oriented top plate 16 mounted on top of the sides and which may overlap one or more of the sides as shown. Plate 16 is used for receiving and positioning a workpiece (not shown) that is to be severed. Preferably, a guide bar 17 is fixed to the top plate 16 and oriented perpendicular to the cutting action plane of the apparatus, i.e., the plane in which a blade 29 moves as it travels for cutting operations. In use, one edge of the workpiece is abutted against bar 17 so as to assure a true right-angle cut through the workpiece relative to its edge abutted bar 17.

Shearing assembly 20 includes horizontal receiver bar 22, which is functionally the rear side discussed in the previous paragraph; and further includes a pair of spaced apart vertical guide rods 24 fixed respectively to the receiver bar 22 and extending upwardly therefrom. A pair of retainer blocks 26 are fixed respectively near the top of the guide rods 24. A shearing head 28 is slidingly engaged with the guide rods 24 so that it is movable vertically on the guide rods 24 between a raised position, where the workpiece is able to be inserted under the head 28, and a momentary lowered position, for shearing the workpiece. Head 28 is normally held in its raised position by return springs 40.

The apparatus may be actuated manually or by a linear actuator such as a pneumatic or hydraulic piston.

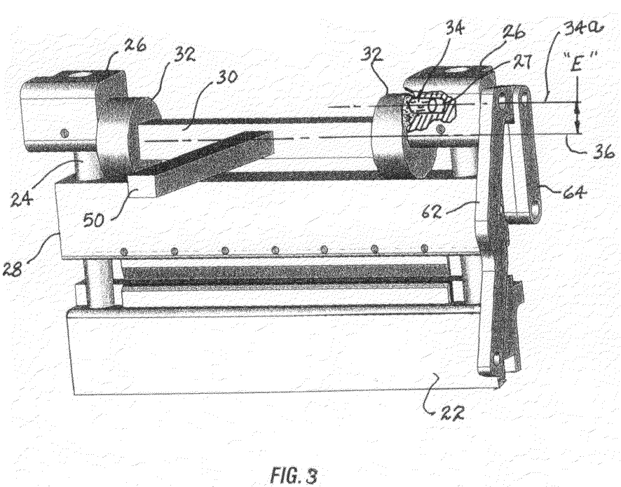

In manual operation, a lever arm 50 is engaged with, and extends from, the camshaft 30 for rotating the camshaft 30 using only arm strength. To accomplish this with more dense or tough materials, the lever arm 50 may be made long enough or extended to generate the necessary moment arm. A camshaft 30 is eccentrically rotatable relative to the retainer blocks 26 so that as it rotates it bears on the shearing head 28 pushing it downwardly against the return springs 40 (preferably compression coil springs as shown) which are preferably engaged respectively with the guide rods 24. By this means a blade 29 mounted in, and a part of, the shearing head 28 is caused to sever the workpiece which is held in place on the top plate 16 and extended between the shearing head 28 and a blade stop; part of receiver bar 22. Camshaft 30 preferably has fixedly mounted thereto, bearing surfaces 32 which bear on head 28. Surfaces 32 may be circular in form, as shown, or may be cam shaped to produce a greater excursion of head 28. Camshaft 30 has an eccentrically positioned rotational axle 34 protruding from each of its ends into receiver holes 27 in retainer blocks 26, see FIG. 3. The axis 34a of axles 34 are laterally displaced relative to the camshaft's longitudinal axis 36, see eccentricity “E” in FIG. 3 which shows head 28 in its extreme downward position and total head excursion (travel) indicated by the visible portions of rods 24 above head 28.

When operated auto-mechanically, i.e., pneumatically or hydraulically, a pair of linear actuators 60 are mounted along the left and right 14 sides respectively of the bed 10. Operation with a single actuator 60 is also possible but not preferably. Each of the linear actuators 60 is engaged with a linkage 65 configured for driving the shearing head 28 downwardly when the linear actuator 60 is actuated, that is, shaft 61 extended as shown in FIG. 1. Each linkage 65 preferably comprises a rocker arm 62 and a push rod 64. The rocker arm 62 is pivotally engaged at its proximal end 62P with the shaft 61 of one of the linear actuators 60, and at its distal end 62D, pivotally with one of the retainer blocks 26. The push rod 64 is pivotally engaged at its upper end 64U with a lateral extension 62E of the distal end 62d of the rocker arm 62, and at its lower end 64L, pivotally with the shearing head 28.

With rotation of the lateral extension 62E, the push rod 64 and shearing head 28 are forced into downward translation to sever the workpiece and are then returned to their upper rest position by springs 40. To accomplish this, actuators 60 are operated by valves (not shown) that are opened only momentarily to drive head 28 to its terminal downward position, and springs 40 then force head 28, push rods 64, rocker arms 62 and actuator arms 61 back to their rest or non-actuated positions.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A material shearing apparatus comprising: a rectangular bed adapted for resting on a surface, the bed having a front, left, right and rear sides, and a horizontally oriented top plate, the top plate extensive between the sides; and mounted to the bed along the rear side, a shearing assembly including:
a) a horizontal receiver bar;
b) a pair of spaced apart vertical guide rods fixed respectively to the receiver bar and extending upwardly therefrom;
c) a pair of retainer blocks fixed respectively at upper positions on the guide rods;
d) a shearing head slidingly engaged with the guide rods, the shearing head movable between raised and lowered positions on the guide rods; and
e) a camshaft rotatable eccentrically in the retainer blocks, the camshaft bearing on the shearing head, the head thereby moveable downwardly against a pair of return springs engaged respectively with the guide rods, thereby driving a blade in the shearing head to sever a workpiece lying in contact with the top plate and extending between the blade and the receiver bar.

2. The apparatus of claim 1 further comprising a guide bar fixed to the top plate and oriented perpendicular to an actuation plane of the blade.

3. The apparatus of claim 1 further comprising a lever arm engaged with the camshaft and extending therefrom for manually rotating the camshaft to sever the workpiece.

4. The apparatus of claim 1 further comprising a pair of linear actuators mounted along the left and right sides respectively, each of the linear actuators engaged with a linkage configured for driving the shearing head downwardly.

5. The apparatus of claim 4 wherein each said linkage comprises a rocker arm and a push rod, the rocker arm pivotally engaged at a proximal end thereof with one of the linear actuators, and at a distal end thereof with one of the retainer blocks; the push rod pivotally engaged at an upper end thereof with a lateral extension of the distal end of the rocker arm, and at a lower end thereof with the shearing head, whereby with rotation of the lateral extension the push rod and shearing head are forced into downward translation.

6. A material shearing apparatus comprising: a horizontal receiver bar; a pair of spaced apart vertical guide rods fixed respectively to the receiver bar and extending upwardly therefrom; a pair of retainer blocks fixed respectively at upper positions on the guide rods; a shearing head slidingly engaged with the guide rods, the shearing head movable between raised and lowered positions on the guide rods; and a camshaft rotatable eccentrically in the retainer blocks, the camshaft bearing on the shearing head, the head thereby moveable downwardly against a pair of return springs, thereby driving a blade in the shearing head toward the receiver bar.

7. The apparatus of claim 6 further comprising a lever arm engaged with the camshaft and extending therefrom for manually rotating the camshaft.

8. The apparatus of claim 6 further comprising a pair of linear actuators mounted along opposing sides respectively of a bed engaged with the receiver bar, each of the linear actuators engaged with a linkage configured for driving the shearing head downwardly.

9. The apparatus of claim 8 wherein each said linkage comprises a rocker arm and a push rod, the rocker arm pivotally engaged at a proximal end thereof with one of the linear actuators, and at a distal end thereof with one of the retainer blocks; the push rod pivotally engaged at an upper end thereof with the distal end of the rocker arm, and at a lower end thereof with the shearing head, whereby with rotation of the rocker arm, the push rod and shearing head are forced into downward translation.
